(19) United States
(12) Patent Application Publication
(10) Pub. No.: US 2010/0000869 A1
(43) Pub. Date: Jan. 7, 2010

(54) Method For Anodizing An Aluminum Material

(75) Inventors: Allen Bai, Taichung City (TW); Fu-Hsiang Yao, Changhua City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: MAW-CHENG ENTERPRISE CO., LTD., Taichung City (TW)

(21) Appl. No.: 12/328,527

(22) Filed: Dec. 4, 2008

(30) Foreign Application Priority Data
Jul. 7, 2008 (TW) 097125534

(51) Int. Cl. B32B 15/04; C25D 11/10

(52) U.S. Cl. 205/50; 205/333

(57) ABSTRACT

A method includes anodizing an aluminum material in an aqueous electrolytic solution containing water and an electrolyte. The electrolyte includes malonic acid and an initiator that contains ammonium ions and anions which are reactable with the ammonium ions to form an ammonium salt. The initiator is formed by dissolving an ammonium salt in the water. The ammonium salt is selected from the group consisting of ammonium acetate, ammonium nitrate, ammonium sulfate, ammonium chlorate, ammonium phosphate, and combinations thereof.

### BACKGROUND OF THE INVENTION

1. Field of the Invention

The invention relates to a method for anodizing an aluminum material, more particularly to a method involving the use of ammonium salt as an initiator in an electrolytic bath.

2. Description of the Related Art

Conventionally, anodizing an aluminum material for forming an aluminum oxide layer on an aluminum substrate or workpiece is normally conducted in a sulfuric acid-based electrolytic solution. U.S. Pat. No. 4,894,127 discloses a method of anodizing an aluminum material for forming an oxide coating to protect aluminum and its alloy. The method includes immersing an aluminum panel in an aqueous electrolytic solution of sulfuric acid and boric acid, ramping the voltage applied across the panel in the electrolytic solution from an initial voltage to a working voltage, and maintaining the working voltage for a time such that the anodic aluminum oxide film thus formed reaches a predetermined weight. Unidirectional pores are normally formed in the aluminum oxide film thus formed, and extend in a normal direction relative to the panel.

U.S. Pat. No. 5,066,368 discloses a process for forming an anodized aluminum component for electronic packaging. The anodizing process is conducted in a sulfuric acid-based electrolyte for forming a porous anodic aluminum oxide film on an aluminum workpiece. The pores formed in the anodic aluminum oxide film are located at the approximate centers of the crystalline grains, and extend in a normal direction relative to the anodic aluminum oxide film. The electrolyte for forming the anodic aluminum film includes an acid solution of sulfuric acid and sulfosalicylic acid. In order to achieve a desired pore size, the current density across the workpiece is required to be raised from zero to a peak value within about three minutes.

U.S. Pat. No. 6,476,409 discloses a nano-structure of an anodic aluminum oxide film for optical device applications. The anodic aluminum oxide film has a plurality of unidirectional pores with different diameters. Formation of the anodic aluminum oxide film is conducted by immersing and anodizing an aluminum workpiece in an acid electrolytic solution, such as an oxalic acid solution, a phosphoric acid solution, a sulfuric acid solution, a chromic acid solution, or the like.

When the anodized aluminum substrate is to be used in electronic package or device applications, such as LED chip, biochip package, and printed circuit board applications, for providing functions, such as insulation and heat dissipation, the breakdown voltage and flatness of the anodic aluminum oxide film formed on the aluminum substrate become crucial to the performance of the packages or the printed circuit boards. However, since formation of the pores in the anodic aluminum oxide film is inevitable due to the use of the acid electrolytic solution, and since the pores thus formed in the aforesaid anodic aluminum oxide films have unidirectional property and are normal to the aluminum substrate, there is a tendency for occurrence of undesired arc and/or short circuit between the anodized aluminum substrate and electronic components installed thereon, which results in a significant reduction in the breakdown voltage of the anodic aluminum oxide film. In addition, a relatively high flatness for the aluminum oxide film on the aluminum substrate to be applied to the packages or the printed circuit boards is required for subsequent formation of conductive contacts or traces on the anodized aluminum substrate. However, in addition to undergoing oxidizing (the least working voltage in an electrolytic bath for achieving a rapid oxidization of aluminum is about 100V, i.e., oxidization is dominant at and above this working voltage), undesired pitting generally occurs from an initial stage of the anodizing process due to corrosive dissolution of the aluminum material in the acid electrolytic solution. Particularly, when malonic acid is to be used as the electrolyte, the pitting corrosion is more prominent and rapid. Since malonic acid is a strong chelating agent, it reacts rapidly with the aluminum material into a complex ion, which is subsequently dissolved in the malonic acid solution, relatively fast. Moreover, when the voltage across the workpiece cannot be raised to the least working voltage within a time limit (preferably within 30 seconds), the pitting will be worse. As a consequence, the surface of the anodic aluminum oxide film thus formed cannot achieve the flatness as required for application to the electronic packages or devices.

Sachiko Ono et al. (“self-ordering of anodic porous alumina formed in organic acid electrolytes”, Electrochimica Acta, Vol. 51, Issue 5, 10 Nov. 2005, pages 827-833) disclosed a process for forming highly ordered cell arrangements (i.e., pore arrangements) in an anodic porous aluminum oxide film for optical applications. The highly ordered cell arrangements can be realized in malonic acid at 120V and tartaric acid at 195V, respectively. The malonic acid employed in the process has a high concentration of about 450 g per one liter of water (about 4.4M). The porous anodic aluminum oxide film thus formed has a breakdown voltage of about 1 kV and a thermal resistance temperature of about 300° C. (i.e. , when a raising temperature reaches the thermal resistance temperature, the anodic porous aluminum oxide film breaks).

### SUMMARY OF THE INVENTION

Therefore, an object of the present invention is to provide a method for anodizing an aluminum material that permits formation of an anodic aluminum oxide film having a high flatness, high mechanical strength, high breakdown voltage, and high thermal resistance temperature.

According to the present invention, there is provided a method for anodizing an aluminum material. The method comprises anodizing an aluminum material in an aqueous electrolytic solution containing water and an electrolyte. The electrolyte includes malonic acid and an initiator that contains ammonium ions and anions which are reactable with the ammonium ions to form an ammonium salt.

### DETAILED DESCRIPTION OF THE PREFERRED EMBODIMENTS

This invention relates to a method for anodizing an aluminum material. The method includes anodizing the aluminum material in an aqueous electrolytic solution containing water and an electrolyte. The electrolyte includes malonic acid, and an initiator capable of fast raising a voltage across the aluminum material in the electrolytic solution from zero voltage to a desired working voltage to quicken oxidation of the aluminum material and capable of stabilizing the current density across the aluminum material to be anodized after the working voltage is achieved.

In some preferred embodiments, the initiator employed in the electrolyte of this invention contains ammonium ions and anions that are reactable with the ammonium ions to form an ammonium salt. Preferably, the initiator is formed by mixing ammonium and a salt of an acid selected from the group consisting of acetic acid, sulfuric acid, hydrochloric acid, nitric acid, and phosphoric acid. More preferably, the initiator is formed by dissolving an ammonium salt in the water. The ammonium salt is selected from the group consisting of ammonium acetate, ammonium nitrate, ammonium sulfate, ammoniumchlorate, ammoniumphosphate, and combinations thereof. Most preferably, the initiator contains ammonium acetate.

With the use of the initiator in combination with the malonic acid in the electrolyte, the least working voltage (110V) to permit rapid oxidation of aluminum can be established within 30 seconds, even with a few seconds when ammonium acetate is used as the initiator, the current density in the electrolytic bath can be stabilized throughout the anodizing process, and formation of the anodic aluminum oxide film can be realized through an external growing mechanism, i.e., aluminum ions are diffused outwardly to an outer surface of the aluminum material to react with OH⁻ ions to form aluminum hydroxide which is subsequently converted into aluminum oxide and water molecule. The external growing mechanism permits growth of the aluminum oxide molecules into a structure having a high mechanical strength, high breakdown voltage, high thermal resistance temperature, and randomly oriented pores. Formation of the randomly oriented pores in the anodic aluminum oxide film can prevent occurrence of the aforesaid arc problem (encountered for unidirectional pores extending in a direction normal to the aluminum substrate), thereby increasing the breakdown voltage, and can increase the mechanical strength. Note that conventional methods of forming anodic aluminum oxide films are known to undergo internal growing mechanism, i.e., OH⁻ ions are diffused inwardly into the aluminum material to react with aluminum ions to form aluminum hydroxide which is then converted into aluminum oxide and water molecule inside the aluminum material, which results in the formation of an anodic aluminum oxide film having a poor mechanical strength, low breakdown voltage, low thermal resistance temperature, and unidirectional pores. The stabilizing of the current density can enhance uniformity in the film thickness of the anodic aluminum oxide film thus formed. Note that the breakdown voltage can be increased to more than 2.0 KV for an anodic aluminum oxide film having a uniform film thickness. In addition, the initiator enables fast raising of the voltage across the aluminum material to be anodized from zero to the working voltage, thereby alleviating occurrence of undesired pits during anodizing and permitting the anodic aluminum oxide film thus formed to have a high flatness that can meet the flatness requirement for application to electronic packages or devices, such as LED packages, metal core PCB, and the like.

The electrolyte further includes an additive capable of assisting growing of the anodic aluminum oxide film with randomly oriented pores during anodizing the aluminum material in the electrolytic solution. The additive employed in the electrolyte of this invention is preferably a leveling agent or a brightening agent.

In some preferred embodiments, the additive is selected from the group consisting of benzylpyridinium carboxylate-containing material, polyethylenimine, polyvinyl alcohol, trigonelline, indium (III) chloride, and combinations thereof.

In some preferred embodiments, the malonic acid in the aqueous electrolytic solution has a concentration ranging from 0.3M to 3.0M, and more preferably, from 0.5M to 2M. Experiments show that at this concentration range, the malonic acid can facilitate the growth of the anodic aluminum oxide film into a structure having a high mechanical strength.

In some preferred embodiments, the electrolyte contains the malonic acid in an amount ranging from 90 wt % to 98 wt %, the ammonium acetate in an amount ranging from 2 wt % to 7 wt %, and the additive in an amount ranging from 0 wt % to 3 wt %, based on the total weight of the electrolyte. Preferably, the malonic acid is in an amount ranging from 93 wt % to 97.5 wt %, the ammonium acetate is in an amount ranging from 2 wt % to 5 wt %, and the additive is in an amount ranging from 0.5 wt % to 2 wt %, based on the total weight of the electrolyte.

In some preferred embodiments, the anodizing of the aluminum material is conducted under a working voltage ranging from 110V to 220V and a current density ranging from 100 A/m²to 180 A/m². Preferably, the working voltage ranges from 130V to 180V and the current density ranges from 110 A/m² to 130 A/m². At these operating ranges, undesired point discharge phenomenon on the anodized aluminum oxide film during anodizing can be eliminated, and a uniform film thickness for the anodic aluminum oxide film can be achieved.

In some preferred embodiments, the anodizing of the aluminum material is conducted by ramping the voltage applied across the aluminum material in the electrolytic solution from 0V to the working voltage within 30 seconds, followed by maintaining the working voltage for a time until a predetermined thickness of the anodic aluminum oxide film is achieved. In some preferred embodiments, the thickness of the anodic aluminum oxide film thus formed ranges from 20 μm to 60 μm.

In some preferred embodiments, the working temperature during anodizing ranges from 5° C. to 50° C. Preferably, the working temperature is room temperature.

In some preferred embodiments, the anodic aluminum oxide film thus formed has a hardness that ranges from 250 Hv to 550 Hv, a thermal resistance temperature that ranges from 350° C. to 460° C., and a breakdown voltage that ranges from 1.2 KV to 2.1 KV.

The merits of the method for anodizing an aluminum material of this invention will become apparent with reference to the following Examples and Comparative Examples.

### EXAMPLE 1 (E1)

An aluminum substrate (product name: A16061, available from Harvard Enterprises Ltd., Taiwan) having a purity of greater than 99% was immersed in an electrolytic solution containing an electrolyte of 176 g of malonic acid (from Merck company), 4 g of ammonium acetate (from Merck company), 0.9 g of trigonelline (from BASF company), and 0.02 g of indium(III) chloride (from BASF company) in one liter of deionized water. Lead (Pb) electrode was used as a cathode. The working temperature of the electrolytic solution was about 20° C. The voltage applied to the electrolytic solution was ramped from 0V to a working voltage of 170V. The ramping time was about 9.4 seconds. The working voltage was then maintained at 170V for about 80 minutes under a current density of about 130 A/m². After anodizing, the anodized aluminum substrate was removed from the electrolytic solution and was rinsed with deionized water. Samples of the cleaned anodized aluminum substrate were prepared, and were subjected to thermal resistance and breakdown tests and hardness measurement, respectively. The thermal resistance test was conducted by placing the test sample in an oven, followed by gradually raising the oven temperate until cracks were observed on the surface of the test sample. The breakdown voltage was conducted by gradually increasing a voltage applied across the test sample until arc or short circuit was observed on the test sample. The hardness test was conducted in accordance with ASTM E384 standard test method.

### Examples 2-9 (E2-E9) and Comparative Examples 1-2 (CE1-CE2)

Anodized aluminum substrates of Examples 2-9 (E2-E9) and Comparative Examples 1-2 (CE1-CE2) were prepared in a manner similar to that of Example 1, except that the content of the electrolyte and the anodizing conditions were varied. Table 1 shows the content of the electrolytes for Examples 1-9 and Comparative Examples 1-2, and Table 2 shows the anodizing conditions for Examples 1-9 and Comparative Examples 1-2.

TABLE 1

| | Content of Electrolyte* | | | | | | | | | | |
|---|---|---|---|---|---|---|---|---|---|---|---|
| | (per one liter of water) | | | | | | | | | | |
| | MA | | | AA | | BPC | | TG | | IC | |
| | Conc. M | wt g | wt % | wt g | wt % | wt g | wt % | wt g | wt % | wt g | wt % |
| E1 | 1.7 | 176 | 97.3 | 4 | 2.2 | — | — | 0.9 | 0.5 | 0.02 | — |
| E2 | 1.5 | 156 | 97.1 | 4 | 2.5 | — | — | 0.7 | 0.4 | 0.02 | — |
| E3 | 1.3 | 136 | 97 | 4 | 2.9 | 0.14 | 0.1 | — | — | 0.02 | — |
| E4 | 0.75 | 78 | 96.9 | 2 | 2.5 | 0.48 | 0.6 | — | — | 0.02 | — |
| E5 | 0.37 | 38 | 93.8 | 2 | 4.9 | 0.48 | 1.3 | — | — | 0.02 | — |
| E6 | 0.17 | 18 | 87.8 | 2 | 9.8 | 0.48 | 2.4 | — | — | 0.02 | — |
| E7 | 0.16 | 17 | 82.9 | 3 | 14.7 | 0.48 | 2.4 | — | — | 0.02 | — |
| E8 | 0.15 | 15 | 77 | 4 | 20.5 | 0.48 | 2.5 | — | — | 0.02 | — |
| E9 | 0.13 | 13.8 | 71.1 | 5 | 25.8 | 0.6 | 3.1 | — | — | 0.02 | — |
| CE1 | 0.75 | 78 | 99.4 | — | — | 0.48 | 0.6 | — | — | 0.02 | — |
| CE2 | 0.75 | 78 | 100 | — | — | — | — | — | — | — | — |

*MA: Malonic Acid
AA: Ammonium Acetate
BPC: benzylpyridinium carboxylate
TG: Trigonelline
IC: Indium(III) Chloride

TABLE 2

| | | Ramping | | Current | Working | Anodizing |
|---|---|---|---|---|---|---|
| | | time | Working | density | temp. | time |
| | cathode | seconds | voltage V | A/m² | ° C. | minutes |
| E1 | Pt | 9.4 | 170 | 130 | 20 | 80 |
| E2 | Pt | 8.5 | 160 | 120 | 10 | 70 |
| E3 | Pt | 7.7 | 130 | 115 | 5 | 60 |
| E4 | Pt | 7.3 | 150 | 110 | 30 | 40 |
| E5 | Cu | 6.2 | 180 | 125 | 40 | 40 |
| E6 | Pb | 5.1 | 200 | 150 | 50 | 40 |
| E7 | Pb | 3.7 | 208 | 156 | 10 | 40 |
| E8 | Pb | 1.7 | 213 | 163 | 10 | 40 |
| E9 | Pb | 1.2 | 219 | 167 | 10 | 40 |
| CE1 | Pt | ∞ | 45 | 66 | 50 | 40 |
| CE2 | Pt | ∞ | 46 | 61 | 50 | 40 |

Table 3 shows the test results for the anodic aluminum oxide films of Examples 1-9 and Comparative Examples 1 and 2.

TABLE 3

| | | | breakdown | thermal resistance |
|---|---|---|---|---|
| | thickness | hardness | voltage | temperature |
| | μm | Hv | kV | ° C. |
| E1 | 55 | 540 | 2.1 | 460 |
| E2 | 50 | 545 | 1.9 | 450 |
| E3 | 45 | 550 | 1.75 | 460 |
| E4 | 38 | 535 | 1.7 | 450 |
| E5 | 34 | 530 | 1.65 | 435 |
| E6 | 31 | 252 | 1.5 | 405 |
| E7 | 39 | 282 | 1.53 | 350 |
| E8 | 38 | 292 | 1.23 | 360 |
| E9 | 23 | 250 | 1.0 | 263 |
| CE1 | 2 | 145 | 0.06 | 102 |
| CE2 | 1 | 145 | 0.02 | 95 |

The results show that each of Examples 1-9 (with ammonium acetate in the electrolyte) has a ramping time of less than 10 seconds, while Comparative Examples 1 and 2 (without ammonium acetate in the electrolyte) cannot build up the voltage across the workpiece to the least working voltage. In addition, the results also show that each of Examples 1-9 has a much higher breakdown voltage, a much higher hardness, and a much higher thermal resistance temperature than those of Comparative Examples 1 and 2.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for anodizing an aluminum material, comprising:
anodizing an aluminum material in an aqueous electrolytic solution containing water and an electrolyte, the electrolyte including malonic acid and an initiator that contains ammonium ions and anions which are reactable with the ammonium ions to form an ammonium salt.

2. The method of claim 1, wherein the initiator is formed by dissolving an ammonium salt in the water, the ammonium salt being selected from the group consisting of ammonium acetate, ammonium nitrate, ammonium sulfate, ammonium chlorate, ammonium phosphate, and combinations thereof.

3. The method of claim 2, wherein the ammonium salt is ammonium acetate.

4. The method of claim 1, wherein the malonic acid has a concentration ranging from 0.3M to 3M.

5. The method of claim 1, wherein the electrolyte further includes an additive selected from the group consisting of benzylpyridinium carboxylate-containing material, polyethylenimine, polyvinyl alcohol, trigonelline, indium (III) chloride, and combinations thereof.

6. The method of claim 5, wherein the malonic acid is in an amount ranging from 90 wt % to 98 wt %, the ammonium acetate is in an amount ranging from 2 wt % to 7 wt %, and the additive is in an amount ranging from 0 wt % to 3 wt %, based on the total weight of the electrolyte.

7. The method of claim 6, wherein the anodizing of the aluminum material is conducted by ramping the voltage applied across the aluminum material in the electrolytic solution from 0V to a working voltage ranging from 130V to 180V within 10 seconds, followed by maintaining the working voltage for a predetermined time.

8. The method of claim 7, wherein the anodizing of the aluminum material is conducted under a current density ranging from 100 A/m² to 180 A/m².

9. An anodized aluminum material prepared by a method comprising anodizing an aluminum material in an aqueous electrolytic solution containing water and an electrolyte, the electrolyte including malonic acid and an initiator that contains ammonium ions and anions which are reactable with the ammonium ions to form an ammonium salt.
